(19) United States
(12) Patent Application Publication
(10) Pub. No.: US 2022/0058666 A1
(43) Pub. Date: Feb. 24, 2022

(54) ESTIMATION AND USE OF DUPLICATION FACTORS FOR AUDIENCE MEASUREMENT

(71) Applicant: The Nielsen Company (US), LLC, New York, NY (US)

(72) Inventors: Michael Sheppard, Holland, MI (US); Jonathan Sullivan, Hurricane, UT (US); Ludo Daemen, Duffel (BE); Edward Murphy, North Stonington, CT (US); DongBo Cui, Fresh Meadows, NY (US)

(21) Appl. No.: 17/408,158

(22) Filed: Aug. 20, 2021

Related U.S. Application Data
(60) Provisional application No. 63/068,472, filed on Aug. 21, 2020.

(51) Int. Cl. G06Q 30/02; G06F 17/18

(52) U.S. Cl. CPC G06Q 30/0201; G06F 17/18

(57) ABSTRACT

Methods, apparatus, systems and articles of manufacture (e.g., physical storage media) to estimate and use duplication factors for audience measurement are disclosed. Example apparatus disclosed herein are to access first marginal ratings values that represent respective portions of a first population associated with corresponding ones of a plurality of media segments, estimate the duplication factor based on a difference between a sum of the first marginal ratings values and a largest one of the first marginal ratings values, access second marginal ratings values that represent respective portions of a second population associated with corresponding ones of the media segments, and output, based on the duplication factor and the second marginal ratings values, a reach value for a union of the media segments, the reach value to represent a number of unique individuals of the second population associated with at least one of the media segments.

### RELATED APPLICATION(S)

This patent claims the benefit of and priority to U.S. Provisional Application No. 63/068,472, titled “FRECHET RATIO AS REPLACEMENT FOR DUPLICATION FACTOR” and filed Aug. 21, 2020. U.S. Provisional Application No. 63/068,472 is hereby incorporated by reference in its entirety.

### FIELD OF THE DISCLOSURE

This disclosure relates generally to audience measurement and, more particularly, to estimation and use of duplication factors for audience measurement.

### BACKGROUND

Determining a size and demographics of an audience of a media presentation helps media providers and distributors schedule programming and determine a price for advertising presented during the programming. Also, accurate estimates of audience demographics enable advertisers to target advertisements to certain types and sizes of audiences. To collect these demographics, an audience measurement entity may enlist a group of media consumers (often called panelists) to cooperate in an audience measurement study (often called a panel) for a predefined length of time. In some examples, the audience measurement entity obtains (e.g., directly, or indirectly from a media service provider) return path data (e.g., census data representative of a population of users) from media presentation devices (e.g., set-top boxes) that identifies tuning data from the media presentation device. In some examples, the media consumption habits and demographic data associated with the enlisted media consumers are collected and used to statistically determine the size and demographics of the entire audience of the media presentation. In some examples, this collected data (e.g., data collected via measurement devices) may be supplemented with survey information, for example, recorded manually by the presentation audience members.

### BRIEF DESCRIPTION OF THE DRAWINGS

FIG. 1 is a block diagram of an example audience measurement environment including example population reach determination circuitry to estimate and use duplication factors for audience measurement in accordance with teachings of this disclosure.

FIG. 2 is a block diagram of a first example implementation of the population reach determination circuitry of FIG. 1.

FIG. 3 is a block diagram of a second example implementation of the population reach determination circuitry of FIG. 1.

FIGS. 4 and 5 are flowcharts representative of example machine readable instructions that may be executed by example processor circuitry to implement the population reach determination circuitry of FIGS. 1 and/or 2.

FIGS. 6-8 are flowcharts representative of example machine readable instructions that may be executed by example processor circuitry to implement the population reach determination circuitry of FIGS. 1 and/or 3.

FIG. 9 is a block diagram of an example processor platform including processor circuitry structured to execute the example machine readable instructions of FIGS. 4, 5, 6, 7 and/or 8 to implement the example population reach determination circuitry of FIGS. 1, 2 and/or 3.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 4, 5, 6, 7 and/or 8) to client devices associated with end users and/or consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts, elements, etc. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Audience measurement entities seek to understand the composition and size of audiences of media, such as television programming. Such information allows audience measurement entity researchers to, for example, report advertising delivery and/or targeting statistics to advertisers that target their media (e.g., advertisements) to particular audiences. Also, such information helps to establish advertising prices commensurate with audience exposure and demographic makeup (referred to herein collectively as “audience configuration”). One way to gather media presentation information is to gather the media presentation information from media output devices (e.g., gathering television presentation data from a set-top box (STB) connected to a television). As used herein, media presentation includes media output by a media device regardless of whether or not an audience member is present (e.g., media output by a media output device at which no audience is present, media exposure to an audience member(s), etc.).

A media presentation device (e.g., STB) provided by a service provider (e.g., a cable television service provider, a satellite television service provider, an over-the-top (OTT) service provider, a music service provider, a movie service provider, a streaming media provider, etc.) or purchased by a consumer may contain processing capabilities to monitor, store, and transmit tuning data (e.g., which television channels are tuned by the media presentation device at a particular time) back to the service provider, which can then aggregate and provide such return path data to an audience measurement entity (e.g., The Nielsen Company (US), LLC) to analyze media presentation activity. Data transmitted from a media presentation device back to the service provider is referred to herein as return path data which may include census data. Return path data includes tuning data. Tuning data is based on data received from the media presentation device while the media presentation device is on (e.g., powered on, switched on, and/or tuned to a media channel, streaming, etc.). Although return path data includes tuning data, return path data may not include data related to the user viewing the media corresponding to the media presentation device. Accordingly, return path data may not be able to be associated with specific viewers, demographics, locations, etc. However, census data may be derived or extracted from return path data. Census data is indicative of the total percentage of a population of users (e.g., based on the return path data) that was exposed to media at a particular media segment. For example, if 20% of a population was exposed to a first media segment (e.g., a first 15 minute segment) of a television show, the census data may be indicative of the 20% exposure.

To determine aspects of media presentation data (e.g., which household member is currently consuming a particular media and the demographics of that household member), market researchers may perform audience measurement by enlisting a subset of the media consumers as panelists. Panelists or monitored panelists are audience members (e.g., household members, users, panelists, etc.) enlisted to be monitored, who divulge and/or otherwise share their media activity and/or demographic data to facilitate a market research study. An audience measurement entity typically monitors media presentation activity (e.g., viewing, listening, etc.) of the monitored panelists via audience measurement system(s), such as a metering device(s) and/or a local people meter (LPM). Audience measurement typically includes determining the identity of the media being presented on a media output device (e.g., a television, a radio, a computer, etc.), determining data related to the media (e.g., presentation duration data, timestamps, channel data, etc.), determining demographic information of an audience, and/or determining which members of a household are associated with (e.g., have been exposed to) a media presentation. For example, an LPM in communication with an audience measurement entity communicates audience measurement (e.g., metering) data to the audience measurement entity. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In some examples, metering data (e.g., including media presentation data) collected by an LPM or other meter is stored in a memory and transmitted via a network, such as the Internet, to a datastore managed by the audience measurement entity. Typically, such metering data is combined with additional metering data collected from a group of LPMs monitoring a group of panelist households. The metering data may include, but are not limited to, a number of minutes a household media presentation device was tuned to a particular channel, a number of minutes a household media presentation device was used (e.g., consumed) by a household panelist member and/or a visitor (e.g., a presentation session), demographics of the audience (which may be statistically projected based on the panelist data), information indicative of when the media presentation device is on or off, and/or information indicative of interactions with the media presentation device (e.g., channel changes, station changes, volume changes, etc.), etc. As used herein, a channel may be a tuned frequency, selected stream, an address for media (e.g., a network address), and/or any other identifier for a source and/or carrier of media.

Examples disclosed herein receive the marginal ratings data for a group of media segments (e.g., different episodes of a television series, different quarter hour time slots of a television program, or a radio program, etc.) and estimates a population reach (e.g., a total number of deduplicated users that were exposed to media) across a union of the media segments. As used herein, a media segment refers to any segment (or division, subpart, etc.) associated with exposure to media. For example, if the media corresponds to advertisement, the media segments may correspond to different websites that include the advertisement. In another example, if the media corresponds to a one-hour program, the media segments may correspond to four, 15-minute increments of the one-hour program. In yet another example, the media segments may correspond to different types of media devices that can be used to access and present the media of interest.

As used herein, a population reach value for a union (or combination, aggregation, etc.) of media segments (e.g., a union of program episodes, and union of quarter hour time slots, a union of websites, a union of media device types, etc.) represents a number of unique individuals of a population (also referred to as a deduplicated audience) that are associated with (e.g., exposed to, accessed, used, etc.) at least one of the media segments. For example, a reach value can be a count of the number of unique individuals of a population that are associated with (e.g., exposed to, accessed, used, etc.) at least one of the media segments, a percentage of the population that is associated with (e.g., exposed to, accessed, used, etc.) at least one of the media segments, etc. As such, the population reach value quantifies the deduplicated audience associated with the union of the media segments of interest.

In some examples, the audience measurement entity processes the collected and/or aggregated metering data from panelist meters and obtains (e.g., from one or more service provider) return path data for devices where a panel is not maintained. Return path data may include, for example, a total number of or a percentage of unique users (e.g., deduplicated users) from a universe of users that was exposed to media within different media segments (e.g., 15 minute increments, via different websites, via different media device types, etc.). However, return path data may be missing a total number of or a percentage of unique users from a universe of users (e.g., a population) that was exposed to the media within a union of the media segments (e.g., across the group of 15-minute increments, across the different websites, across the different media types, etc.). Some examples disclosed herein leverage panelist data to be able to estimate population reach across unions of media segments. Some examples disclosed herein leverage historical census data to be able to estimate population reach across unions of media segments.

For example, some technical solutions disclosed herein access first marginal ratings values for a group of media segments, such that respective ones of the first marginal ratings values represent respective portions of a first population associated with corresponding ones of the media segments. Disclosed example technical solutions also estimate a duplication factor based on a difference between a sum of the first marginal ratings values and a largest one of the first marginal ratings values. Disclosed example technical solutions further access second marginal ratings values for the plurality of media segments, such that respective ones of the second marginal ratings values represent respective portions of a second population associated with corresponding ones of the media segments. Disclosed example technical solutions also output, based on the duplication factor and the second marginal ratings values, a reach value for a union of the media segments. The reach value represents a number of unique individuals of the second population associated with at least one of the media segments.

In some examples, the first population may correspond to a panel population and the second population may correspond to a census population. In some examples, the reach value is a second reach value, and the technical solutions access a first reach value for the union of media segments, wherein the first reach value represents a number of unique individuals of the first population associated with at least one of the media segments. In some such examples, the technical solutions estimate the duplication factor based on the first reach value and the difference between the sum of the marginal ratings values and the largest one of the first marginal ratings values. For example, to estimate the duplication factor, such example technical solutions may subtract the largest one of the first marginal ratings values from the first reach value to determine a difference value, and divide the difference value by the difference between the sum of the marginal ratings values and the largest one of the first marginal ratings values to determine the duplication factor.

In some examples, the first population corresponds to a historical version of the second population such that the first population may be associated with a first interval prior to a second time interval of the second population. For example, the second population maybe a current census population and the first population may be a historical version of the census population. In some such examples, the reach value is a second reach value, and the technical solutions access a first reach value for the union of media segments, wherein the first reach value represents a number of unique individuals of the first population associated with at least one of the media segments. In some such examples, the technical solutions estimate the duplication factor based on the first reach value and the difference between the sum of the marginal ratings values and the largest one of the first marginal ratings values. For example, the technical solutions may perform a regression analysis with an independent variable based on the difference and a dependent variable based on the first reach value to determine parameter values of a double exponential model, and evaluate the double exponential model based on the parameter values and the second marginal ratings values to estimate the duplication factor. As another example, the technical solutions may perform a regression analysis based on the difference and the first reach value to estimate the duplication factor, and solve a system of equations to determine the second reach value, wherein the system of equations are based on the duplication factor and the second marginal ratings values.

In some examples, the difference is a first difference, and the technical solutions determine a second difference between a sum of the second marginal ratings values and a largest one of the second marginal ratings values, and add the largest one of the second marginal ratings values to a product of the second difference and the duplication factor to determine the reach value.

These and other example methods, apparatus, systems and articles of manufacture (e.g., physical storage media) to estimate and use duplication factors for audience measurement are disclosed in further detail below.

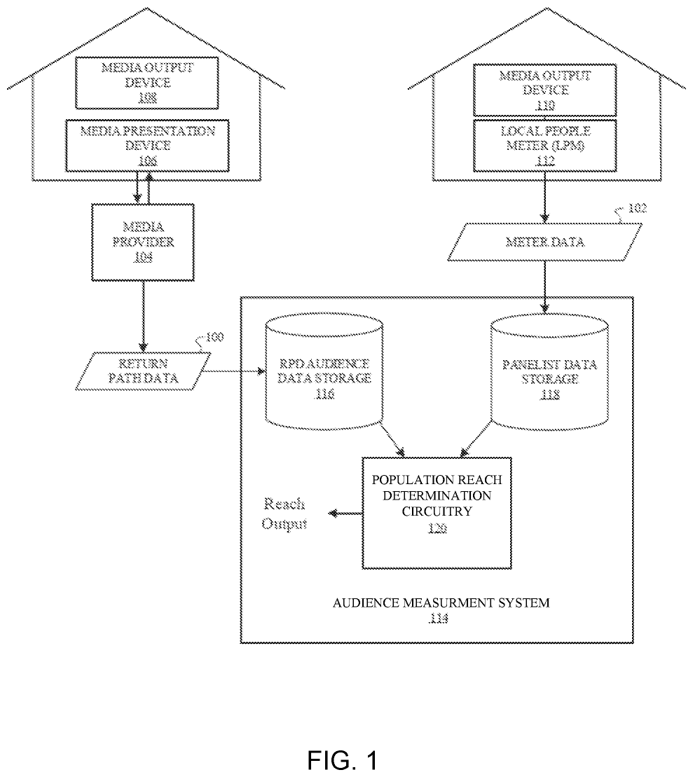

Turning to the figures, FIG. 1 is a block diagram of an environment in which example return path data 100 and, in some examples, example meter data 102 are collected to determine estimate and use duplication factors to determine population reach values based on marginal ratings values obtained for market segments. FIG. 1 includes the example return path data 100, the example meter data 102, an example media provider 104, an example media presentation device 106, example media output devices 108, 110, an example local people meter (LPM) 112, and an example audience measurement entity (AME) 114. The example audience measurement entity 114 includes an example return path data (RPD) audience storage 116, an example panelist data storage 118, and example population reach determination circuitry 120.

The example media provider 104 of FIG. 1 is a service provider (e.g., cable media service provider, a radio frequency (RF) media provider, a satellite media service provider, etc.) that presents media to an audience member via the example media presentation device 106. The media provided by the example media provider 104 is transmitted (e.g., via a wired or wireless network connection) to the media presentation device 106. The media presentation device 106 is connected, via a wired or wireless connection, to the example media output device 108 to output the media to an audience member. The media output device 108 is a device capable of outputting the received media. For example, the media output device 108 may be a television, a radio, speakers, a projector, a computer, a computing device, a tablet, a mobile device, and/or any other device capable of outputting media.

When the example media presentation device 106 of FIG. 1 is operating to access media, the media presentation device 106 receives media corresponding to a station, program, website, etc., based on the tuning of the example media presentation device 106. For example, the media presentation device 106 may be a set-top box. Additionally or alternatively, the example media presentation device 106 may be an over-the-top (OTT) device, a video game console, a digital video recorder (DVR), a digital versatile disc (DVD) player, a receiver, a router, a server, a computer, a mobile device, software executed by a website, computer, and/or application, and/or any device that receives media from a service provider. For example, the media presentation device 106 may be a website and/or application that provides media to users via the media output device 108. In some examples, the media presentation device 106 may implement a DVR and/or DVD player. In some examples, the example media presentation device 106 includes a unique serial number that, when associated with subscriber information, allows an audience measurement entity, a marketing entity, and/or any other entity to ascertain specific subscriber behavior information.

By way of example, the example media presentation device 106 may be tuned to channel 5. In such an example, the media presentation device 106 outputs media (from the example media provider 104) corresponding to the tuned channel 5. The media presentation device 106 may gather tuning data corresponding to which channels, stations, websites, etc., that the example media presentation device 106 was tuned. The example media presentation device 106 generates and transmits the example return path data 100 (e.g., census data corresponding to the total population of users) to the example media provider 104. The example return path data 100 includes the tuning data and/or data corresponding to the example media provider 104. Although the illustrated example of FIG. 1 includes the example media provider 104 receiving the example return path data 100 from one media presentation device (e.g., the example media presentation device 106), at one location, corresponding to one media provider (e.g., the example media provider 104), the example media provider 104 may receive return path data 100 from any number or type(s) of media presentation devices, at any number of locations. The media provider 104 transmits the collected return path data 100 to the example audience measurement entity 114. Additionally or alternatively, the audience measurement entity 114 may be hosted by any other entity or may be co-hosted by another entity(ies). For example, the example return path data 100 may be collected from the example media presentation devices 106 by a media provider (e.g., a cable television provider, a satellite television provider, etc.) and the example meter data 102 may be collected from an LPM (e.g., such as the example LPM 112) by the example audience measurement entity 114 cooperating with the media provider to gain access to the tuning data. The example audience measurement entity 114 includes the example return path data audience storage 116 (e.g., a database) and the example panelist data storage 118 (e.g., a database).

The example media output device 110 of FIG. 1 is a device capable of outputting the received media. For example, the media output device 110 may be a television, a radio, speakers, a projector, a computer, a computing device, a tablet, a mobile device, and/or any other device capable of outputting media. In some examples, the media output device 110 receives media over-the-air. In this manner, the media output device 110 receives media via an antenna and does not correspond to a media provider (e.g., including the example media provider 104). In the illustrated example of FIG. 1, the media output device 110 corresponds to one or more monitored panelists. The example LPM 112 monitors the panelists exposure to media output by the example media output device 110. For example, the example LPM 112 is in communication with the example media output device 110 to collect and/or capture signals emitted externally by the media output device 110. The LPM 112 may be coupled with the media output device 110 via wired and/or wireless connection. The example LPM 112 may be implemented in connection with additional and/or alternative types of media presentation devices, such as, for example, a radio, a computer monitor, a video game console, and/or any other device capable of presenting media to a user. The LPM 112 may be a portable people meter, a cell phone, a computing device, a sensor, and/or any other device capable of metering (e.g., monitoring) user exposure to media. In some examples, a media presentation location may include a group of LPMs 112. In such examples, the group of the LPMs 112 may be used to monitor media exposure for multiple users and/or media output devices 110. Additionally, the example panelist data storage 118 receives and stores the example meter data 102 from the example LPM 112.

In some examples, the example LPM 112 of FIG. 1 includes a set of buttons assigned to audience members to determine which of the audience members is watching the example media output device 110. The LPM 112 may periodically prompt the audience members via a set of LEDs, a display screen, and/or an audible tone, to indicate that the audience member is present at a first media presentation location by pressing an assigned button. In some examples, to decrease the number of prompts and, thus, the number of intrusions imposed upon the media consumption experience of the audience members, the LPM 112 prompts only when unidentified audience members are located at the first media presentation location and/or only after the LPM 112 detects a channel change and/or a change in state of the media output device 110. In other examples, the LPM 112 may include at least one sensor (e.g., a camera, 3-dimensional sensor, etc.) and/or be communicatively coupled to at least one sensor that detects a presence of the user in a first example media presentation location. The example LPM 112 transmits the example meter data 102 to a media researcher and/or a marketing entity. The example meter data 102 includes the media presentation data (e.g., data related to media presented while the media output device 110 is on and a user is present). The example meter data 102 may further include a household identification, a tuner key, a presentation start time, a presentation end time, a channel key, etc. Although the illustrated example illustrates the example audience measurement entity 114 collecting the example meter data 102 from one LPM 112 at one location, the example audience measurement entity 114 may collect meter data from any number or type of meters at any number of locations.

The example return path data 100 of FIG. 1 from the example media presentation device 106 and/or the example meter data 102 from the example LPM 112 is transmitted to the example audience measurement entity 114 via a network. The network may be implemented using any type of public or private network, such as, but not limited to, the Internet, a telephone network, a local area network (LAN), a cable network, and/or a wireless network. To enable communication via the network, the example media presentation device 106 includes a communication interface that enables a connection to an Ethernet medium, a digital subscriber line (DSL), a telephone line, a coaxial cable, or any wireless connection, etc.

The example return path data audience storage 116 of the example AME 114 of FIG. 1 collects the example return path data 100 corresponding to the example media presentation device(s) 106. As described above, the example return path data 100 includes tuning data of the example media presentation device 106. However, in some examples, the example return path data 100 may not include specific data identifying any information relating to the audience of the example media output device 108. In such examples, another device and/or processor models such audience information prior to storing in the example return path data audience storage 116. For example, the device and/or processor may assign and/or model virtual users to augment the example return path data 100, thereby generating audience assigned return path data.

In the illustrated example of FIG. 1, the return path data 100 stored in the RPD audience storage 116 is representative of a census population, and includes census data such as census marginal ratings values for one or more groups of media segments. As noted above, a media segment refers to any segment (or division, subpart, etc.) associated with exposure to media. For example, media segments may correspond to different time intervals (e.g., 15-minute time intervals, 30-minute time intervals, 1 hour time-intervals, etc.), or groups/unions of time intervals, during which media exposure (e.g., exposure to television programming, radio programming, commercials, etc.) is to be monitored. As another example, media segments may correspond to different websites, or groups/unions of websites, among a collection of websites for which media exposure (e.g., advertisement exposure, website accesses, etc.) is to be monitored. As yet a further example, media segments may correspond to different types media devices, or groups/unions of media device types, among a collection of media device types (e.g., such as televisions, smartphones, tablets, personal computers, game consoles, etc.) for which media exposure is to be monitored. As still another further example, media segments may correspond to different episodes, or groups/unions of episodes, of one or more media programs (e.g., television programs, radio programs, movies, etc.), media genres, etc., for which media exposure is to be monitored. The foregoing examples of media segments are but a few examples of ways media segments may be specified in the context of monitoring media exposure, performing audience measurement, etc.

As noted above, the RPD audience storage 116 stores census marginal ratings values for one or more groups of media segments. The census marginal ratings may be in the form of counts and/percentages of census population members respectively associated with (e.g., exposed to, having accessed, users of, etc.) one or more of the group of media segments of interest. In some examples, the census population corresponds to the subscriber base of one or more media providers, network (e.g., Internet) service providers, etc. In some examples, the census population corresponds to a population associated with one or more geographic areas (e.g., one or more cities, countries, etc.) As such, the census marginal ratings can correspond to, but are not limited to, counts/percentages of census population members associated with (i) different time intervals, or groups/unions of time intervals, during which media exposure, (ii) different websites, or groups/unions of websites, among a collection of websites for which media exposure is to be monitored, (iii) different types media devices, or groups/unions of media device types, among a collection of media device types for which media exposure is to be monitored, (iv) different episodes, or groups/unions of episodes, of one or more media programs, media genres, etc., for which media exposure is to be monitored, etc. In some examples, the census marginal ratings are computed from the return path data 100 by the population reach determination circuitry 120 and/or another processor resource(s) associated with the AME 114.

Similarly, the panelist data storage 118 stores panel marginal ratings values for one or more groups of media segments. Like the census marginal ratings, the panel marginal ratings may be in the form of counts and/percentages of panel population members respectively associated with (e.g., exposed to, having accessed, users of, etc.) one or more of the group of media segments of interest. However, in contrast with the census population, the panel population corresponds to a group of panelists included one or more panels formed by the AME 114 to monitor media exposure and identify audience demographics for audience measurement associated with the one or more group of media segments of interests. Thus, the panel marginal ratings can correspond to, but are not limited to, counts/percentages of panelists associated with (i) different time intervals, or groups/unions of time intervals, during which media exposure is to be monitored, (ii) different websites, or groups/unions of websites, among a collection of websites for which media exposure is to be monitored, (iii) different types media devices, or groups/unions of media device types, among a collection of media device types for which media exposure is to be monitored, (iv) different episodes, or groups/unions of episodes, of one or more media programs, media genres, etc., for which media exposure is to be monitored, etc. In some examples, the panel marginal ratings are computed from the meter data 102 by the population reach determination circuitry 120 and/or another processor resource(s) associated with the AME 114.

In the illustrated example, because the meter data 102 is also able to provide demographic information and other detailed measurements associated with the panelists, the panelist data storage 118 also stores panel reach values for union(s) (also referred to as combination(s), aggregation(s), etc.) of the one or more groups of media segments of interest. Based on the description of population reach values provided above, a panel reach value for a union of media segments is representative of a number of unique panelists of the panel population (also referred to as a deduplicated panel audience) that are associated with (e.g., exposed to, accessed, used, etc.) at least one of the media segments included in the union of media segments. The panel reach value may be expressed as a count of the number of unique panelists, a percentage of the unique panelists of the panel, etc., which represents a size of the deduplicated panel audience associated with at least one of the media segments included in the union of media segments. Thus, the panel reach values can correspond to, but are not limited to, counts/percentages of unique panelists associated with (i) a union of different time intervals during which media exposure is to be monitored, (ii) a union of different websites among a collection of websites for which media exposure is to be monitored, (iii) a union of media device types among a collection of media device types for which media exposure is to be monitored, (iv) a union of episodes for one or more media programs, media genres, etc., for which media exposure is to be monitored, etc. In some examples, the panel reach values are computed from the meter data 102 by the population reach determination circuitry 120 and/or another processor resource(s) associated with the AME 114.

In the illustrated example, the demographics of the census population is unknown from the return path data 100 and, thus, census reach values are not readily available in the RPD audience storage 116. To provide this missing information, the population reach determination circuitry 120 operates to determine one or more duplication factors that enable determination of census reach values for the census population based on the available census marginal ratings values stored in the RPD audience storage 116 for the census population, and the determined duplication factors. As disclosed in further detail below, in some examples, the population reach determination circuitry 120 determines the duplication factors are based on the panel marginal ratings values and panel reach values stored in the panelist data storage 118 for the panel population. As disclosed in further detail below, in some examples, the population reach determination circuitry 120 determines the duplication factors are based on historical census marginal ratings values and census reach values stored in the RPD audience storage 116 for the census population.

In some examples, a duplication factor is a multiplier that accounts for duplication across population members, devices, platforms, websites, etc., associated with measurement of media exposure for one or more groups of media segments. For example, consider media segments corresponding to different television programs being monitored to determine televisions ratings. Assume there are k programs and nᵢ people were measured as being exposed to the i^{th} program. Thus, nᵢ corresponds to a marginal rating value for the i^{th} program. As each person has the possibility of viewing multiple programs, there may be double counting of people among the nᵢ audiences. To estimate the total de-duplicated audience across all programs, some prior audience measurement techniques compute a duplication factor, d_{f}, according to Equation 1, which is:

$$N = {d}_{f} {\sum }_{i = 1}^{k} {n}_{i} \qquad Equation 1$$

In Equation 1, N represents the de-duplicated audience, or reach value, for the total set of k programs, which corresponds to the number of unique individuals of the population that were exposed to at least one of the programs. In some prior audience measurement techniques, the value of the duplication factor, d_{f}, is determined from Equation 1 using panel data for which the panel marginal rating values and a reach value for the set of k programs are available. The duplication factor, d_{f}, determined from the panel data is then applied to the census marginal rating values, nᵢ, according to Equation 1.

For example, consider an example panel study in which the panel marginal rating values across three programs were {0.10, 0.05, 0.20}, and the panel reach value for the three programs was 0.30. Based on Equation 1, an example prior audience measurement technique described above may compute the duplication factor, d_{f}, according to Equation 2, which is:

$${d}_{f} = \frac{N}{{\sum }_{i = 1}^{k} {n}_{i}} = \frac{0.30}{( 0.10 + 0.05 + 0.20 )} = 0.8571 \qquad Equation 2$$

Thus, in this example, the duplication factor, d_{f}, determined from the panel data indicates that measured panel reach for the three programs was about 85% of the total panel population (or 85% of the total possible reach for the panel population). Next, assume that the census marginal rating values for the three programs were determined from the return path data for a census population to be {0.08, 0.07, 0.25}. The example prior audience measurement technique described above may use Equation 1 to estimate the census reach value, N, based on the duplication factor, d_{f}, determined from the panel data and the census marginal rating values, which yields the following estimate shown in Equation 3:

$$N = {d}_{f} {\sum }_{i = 1}^{k} {n}_{i} = 0.8571 ( 0.08 + 0.07 + 0.25 ) = 0.3428 \qquad Equation 3$$

Thus, in this example, the estimated de-duplicated census audience, or census reach, across the three programs is estimated by the prior audience measurement technique to be 0.3428.

Although the duplication factor, d_{f}, determined above by the example prior audience measurement techniques has some intuitive appeal and is simple to explain, it has some problems. Two of these problems are that the estimated reach resulting from such a prior duplication factor, d_{f}, can exceed 100% (or, in other words, can be greater than the entire population), or that the estimated reach resulting from such a prior duplication factor, d_{f}, could be smaller than the largest ratings. The latter is also impossible because if nᵢ people are in i^{th} category, then at least nᵢ people must be in the total de-deduplicated audience. Equations 4 and 5 provide two examples of estimating reach (or, in other words, the de-duplicated audience) in which the two impossible cases described above can occur:

N=0.5(0.30+0.80+0.40+0.70)=1.1>100% (impossible) Equation 4

N=0.3(0.10+0.20+0.25)=0.165<25% (impossible) Equation 5

The foregoing problems can arise because the example prior audience measurement techniques may not account for some important logical constraints, such as (i) the maximum reach value is bounded above by 100%, and (ii) the minimum reach value is bounded below by the largest marginal rating value. The example prior audience measurement techniques described above may not account for the first logical constraint because the reach is estimated based on a sum of the marginal ratings values multiplied by a scale factor (i.e., the duplication factor, d_{f}). This can cause the problem of the estimated reach being greater than 100% because, even after multiplying the sum of the marginal ratings values by the duplication factor, the post-multiplied value may still be greater than 100%. The example prior audience measurement techniques described above may not account for the second logical constraint described above because there is no modification or allowance to account for the fact that the estimated reach has to be at least as large as the largest marginal audience. Example population reach determination circuitry 120 disclosed herein are designed based on Fréchet inequalities account for both of foregoing logical constraints.

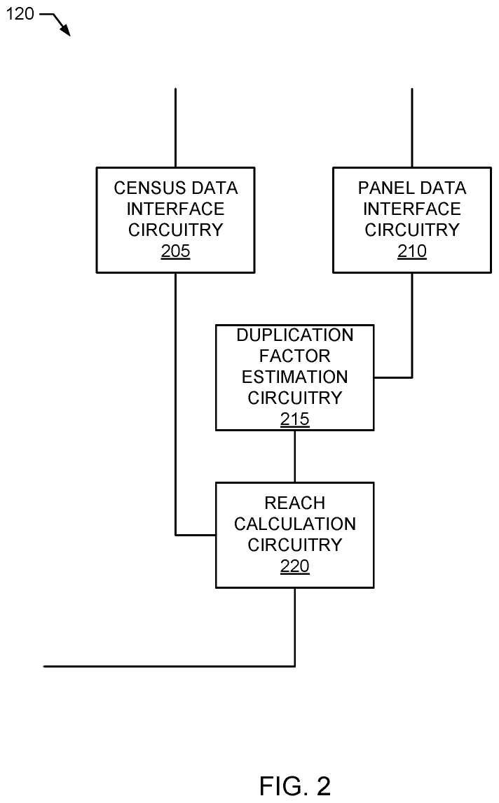

A block diagram of a first example implementation of the population reach determination circuitry 120, which is based on Fréchet inequalities, is illustrated in FIG. 2. The example population reach determination circuitry 120 of FIG. 2 includes example census data interface circuitry 205, example panel data interface circuitry 210, example duplication factor estimation circuitry 215 and example reach calculation circuitry 220. The example population reach determination circuitry 120 of FIG. 2 is based on Fréchet inequalities as follows. For n sets labeled Aᵢ with probability of inclusion in set Aᵢ being Pᵢ=Pr(Aᵢ), then the following Fréchet inequalities are true for the probabilities of intersection of the sets Aᵢ and unions of the sets Aᵢ:

Intersection: max(0,(ΣᵢPᵢ)−(n−1))≤Pr(∩Aᵢ)≤min(Pᵢ)

Union: max(Pᵢ)≤Pr(∪Aᵢ)≤min(1,ΣᵢPᵢ) Equation 6

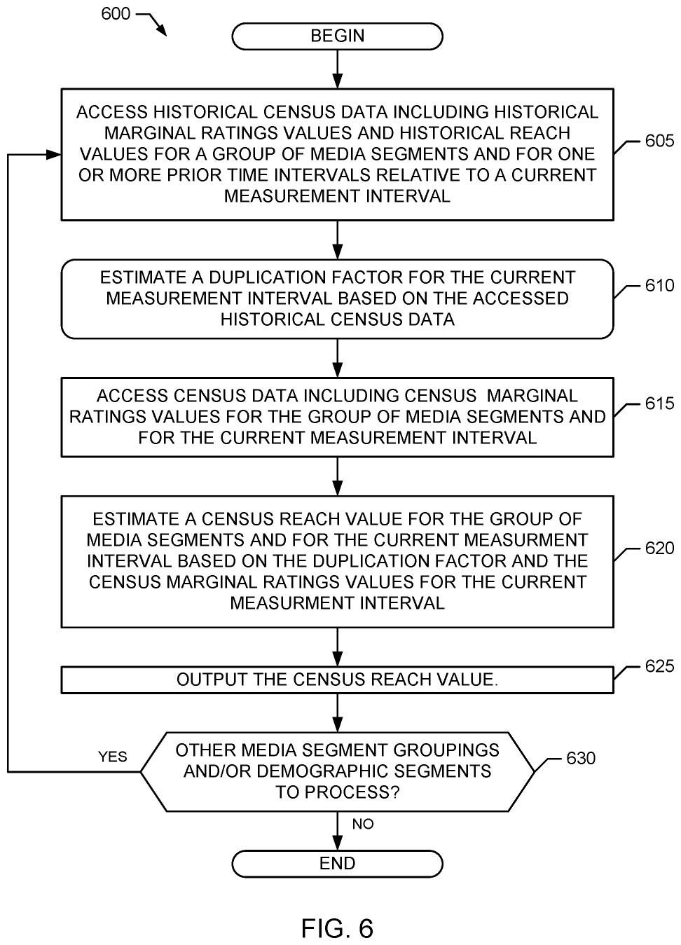

The Fréchet inequalities of Equation 6 can be considered rules about how to bound calculations involving probabilities without assuming independence or, indeed, without makingany dependence assumptions whatsoever. The Union inequality of Equation 6 is relevant to the design of the example population reach determination circuitry 120 of FIG. 6. This is because the sets Aᵢ correspond to the media segments described above, the probabilities Pᵢ=Pr(Aᵢ) correspond to the marginal ratings values described above, and Equation 6 provides that the minimum the probability of being in the union of the sets Aᵢ corresponds to the reach value described above. As such, the Union inequality of Equation 6 provides that the minimum value for the probability of being in the union of the sets Aᵢ (or, in other words, the minimum reach value) is the largest probability Pᵢ=Pr(Aᵢ) (or, in other words, the largest marginal ratings value). Furthermore, the Union inequality of Equation 6 provides that the maximum value for the probability of being in the union of the sets Aᵢ (or, in other words, the maximum reach value) is the sum of the probabilities Pᵢ=Pr(Aᵢ) (or, in other words, the sum of the marginal ratings values), with a ceiling of 100%.

In the illustrated example, the Fréchet inequalities of Equation 6 are used to define a ratio of how far into the theoretical region it is possible for the true union audience (e.g., the true reach value) can be. That is, consider the Union inequality of Equation 6, which reproduced in Equation 7 below

Union: max(Pᵢ)≤Pr(∪Aᵢ)≤min(1,ΣᵢPᵢ) Equation 7

Next, define a Lower Bound value, LB, as the left-hand side of Equation 7, and an Upper Bound value, UB, as the right-hand side of Equation 7. If a true audience reach, A, was measured, where A=Pr(∪ Aᵢ), then the Fréchet ratio, r, can be defined according to Equation 8, which is:

$$r = \frac{A - L B}{U B - L B} \qquad Equation 8$$

If r=0, that would imply that there is complete overlap between the maximum marginal audience and all other smaller marginal audiences. If r=1, that would imply there are either completely disjoint marginal audience sets (mutually exclusive), or that the theoretical maximum reached 100% and audience was, therefore, 100%.

In the illustrated example of FIG. 2, the population reach determination circuitry 120 calculates the duplication factor to be the Fréchet ratio, r, given by Equation 8. Thus, the resulting duplication factor based on Equation 8 is a scalar number that is memory efficient and provides a quick first-order estimate of reach, while having the benefit of ensuring the calculated reach does not fall outside the logical bounds.

As an example of the population reach determination circuitry 120 of FIG. 2 estimating reach based on the duplication factor, r, given by Equation 8, consider a panel study across three media programs that measured panel marginal ratings values of {0.10, 0.05, 0.20} across the three programs, and a panel reach of 0.30 for the three programs. The Fréchet-based duplication factor, r, of Equation 8 for this example is given by Equation 9, which is:

$$r = \frac{0.30 - 0.20}{0.35 - 0.20} = 0.6666 \qquad Equation 9$$

The resulting duplication factor, r, of Equation 9 indicates that the measured panel reach was two-thirds along the range of theoretically possible reach values given the measured panel marginal ratings values. Next, assume that, for a census population, the measured census marginal ratings values are {0.08, 0.07, 0.25}. Using the duplication factor, r, determined from the panel data, the census reach, N, for the three programs can be estimated based on Equation 8, with A being replaced by N as shown in Equation 10, which is:

$$0.6666 = \frac{N - 0.25}{0.40 - 0.25} \qquad Equation 10$$

Rewriting Equation 10 to solve for the census reach N yields Equation 11:

N=0.25+0.6666(0.40−0.25)=0.35 Equation 11

Thus, the estimated census reach value for this example is N=0.35.

Generalizing Equation 11, the population reach determination circuitry 120 of FIG. 2 estimates a census reach value based on the Fréchet-based duplication factor, r, of Equation 8 and the census marginal ratings values according to Equation 12, which is:

N=LB+r(UB−LB) Equation 12

In Equation 12, the value of LB is calculated from the census marginal ratings values using the left-hand side of Equation 7, and the value of UB is calculated from the census marginal ratings values using the right-hand side of Equation 7. As can be seen from Equation 12, even if the value of r was at the extremes of 0 or 1, the corresponding audience reach estimate would still be between the theoretical lower and upper bounds, and, thus, cannot be less than the maximum marginal audience nor greater than 100%.

With the foregoing in mind, the example population reach determination circuitry 120 of FIG. 2 includes the example panel data interface circuitry 210 to access the panelist data storage 118 to obtain the panelist marginal ratings values (e.g., the set of panel Pᵢ values for the media segments Aᵢ) and the panelist reach value (e.g., the panel A value) measured for a given panel population being associated with (e.g., exposed to, accessed, used, etc.) a group of media segments (e.g., the media segments Aᵢ). Likewise, the example population reach determination circuitry 120 of FIG. 2 includes the example census data interface circuitry 205 to access the RPD audience storage 116 to obtain the census marginal ratings values (e.g., the set of census Pᵢ values for the media segments Aᵢ) for a given census population being associated with (e.g., exposed to, accessed, used, etc.) the group of media segments (e.g., the media segments Aᵢ).

The example population reach determination circuitry 120 of FIG. 2 includes the example duplication factor estimation circuitry 215 to estimate a duplication factor based on Equation 8, as described above. Thus, the duplication factor estimation circuitry 215 of the illustrated example estimates the duplication factor (e.g., r) based on a difference (e.g., UB−LB from the panel data) between a sum of the panel marginal ratings values (e.g., UB=ΣᵢPᵢ from the panel data, but limited to 1, or 100%) and a largest one of the panel marginal ratings values (e.g., LB=max (Pᵢ) from the panel data). More specifically, and with reference to Equation 8, in the illustrated example, the duplication factor estimation circuitry 215 estimates the duplication factor, r, by computing a difference (e.g., A−LB) between the panel reach value (A) for the union of media segments and the largest one of the panel marginal ratings values (e.g., LB=max (Pᵢ)), and divides that difference by the difference (e.g., UB−LB) between the sum of the panel marginal ratings values (e.g., UB=ΣᵢPᵢ, but limited to 1, or 100%) and the largest one of the panel marginal ratings values (e.g., LB=max (Pᵢ)).

The example population reach determination circuitry 120 of FIG. 2 includes the example reach calculation circuitry 220 to calculate and output a census reach value based on Equation 12 provided above. Thus, the reach calculation circuitry 220 of the illustrated example calculates and outputs the panel reach value (e.g., N) based on the duplication factor, r, estimated by the duplication factor estimation circuitry 215 and the census marginal ratings values (e.g., the set of census Pᵢ values) for the union of media segments (e.g., the union of the media segments Aᵢ). More specifically, and with reference to Equation 12, in the illustrated example, the reach calculation circuitry 220 determines a difference (e.g., UB−LB based on the census data) between a sum of the census marginal ratings values (e.g., UB=ΣᵢPᵢ from the census data, but limited to 1, or 100%) and a largest one of the census marginal ratings values (e.g., LB=max (Pᵢ) from the census data). The reach calculation circuitry 220 of the illustrated example then adds the largest one of the census marginal ratings values (.g., LB=max (Pᵢ) from the census data) to a product of the computed difference (e.g., UB−LB based on the census data) and the duplication factor (e.g., r) to determine the census reach value (e.g., N) for the union of the media segments (e.g., the union of the media segments Aᵢ).

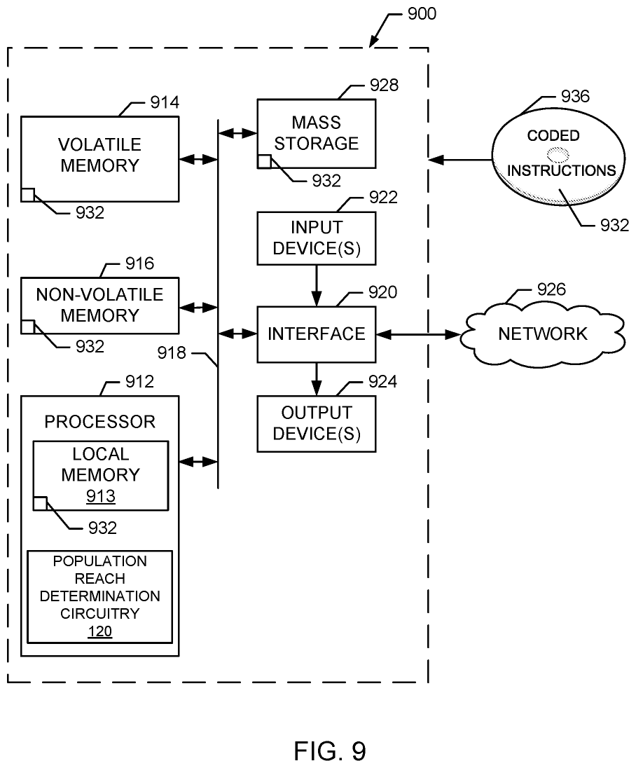

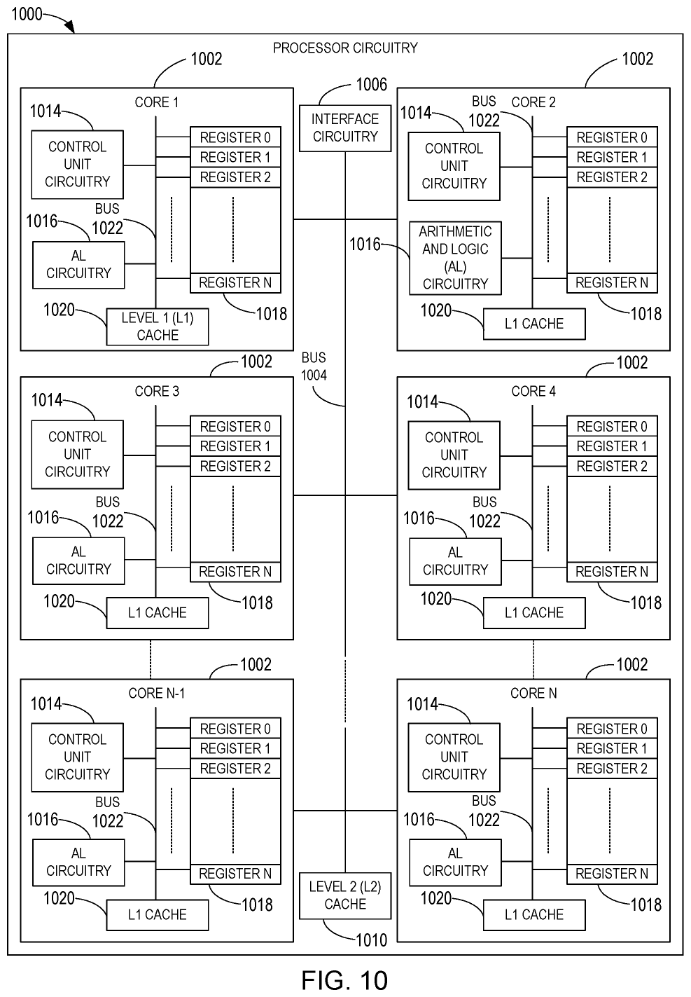

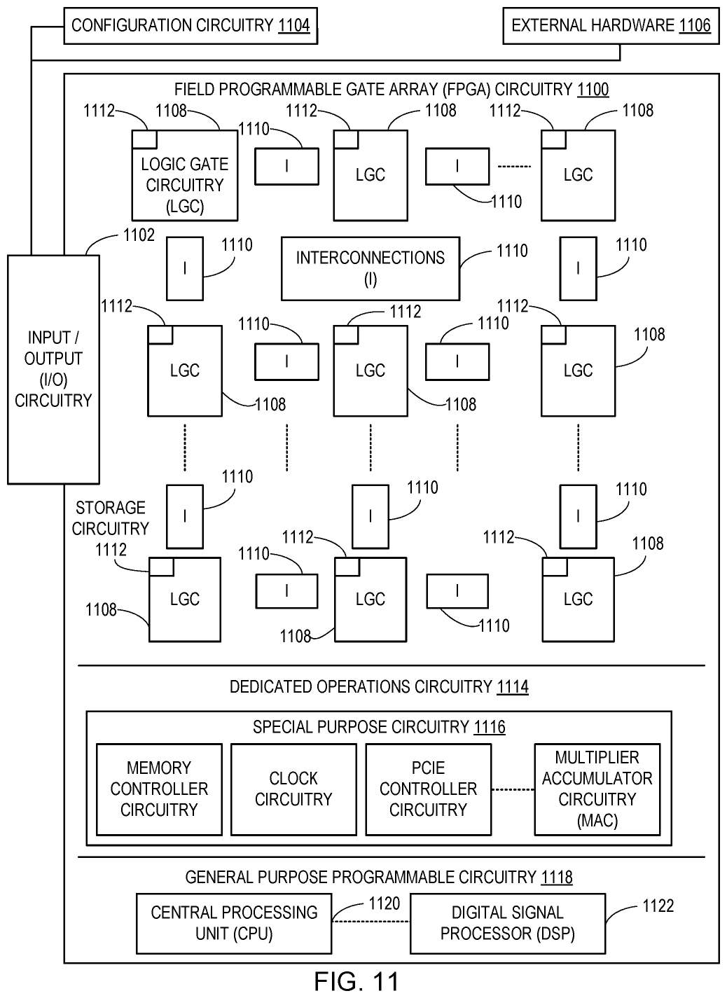

In some examples, the population reach determination circuitry 120 of FIG. 2 includes means for estimating a duplication factor. For example, the means for estimating the duplication factor may be implemented by example duplication factor estimation circuitry 215. In some examples, the duplication factor estimation circuitry 215 may be implemented by machine executable instructions such as that implemented by at least blocks 410, 505, 510, 515, 520 and/or 525 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the duplication factor estimation circuitry 215 is implemented by other hardware logic circuitry, hardware implemented state machines, and/or any other combination of hardware, software, and/or firmware. For example, the duplication factor estimation circuitry 215 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the population reach determination circuitry 120 of FIG. 2 includes means for means for outputting a reach value. For example, the means for outputting the reach value may be implemented by example reach calculation circuitry 220. In some examples, the reach calculation circuitry 220 may be implemented by machine executable instructions such as that implemented by at least blocks 420 and/or 425 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the reach calculation circuitry 220 is implemented by other hardware logic circuitry, hardware implemented state machines, and/or any other combination of hardware, software, and/or firmware. For example, the reach calculation circuitry 220 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

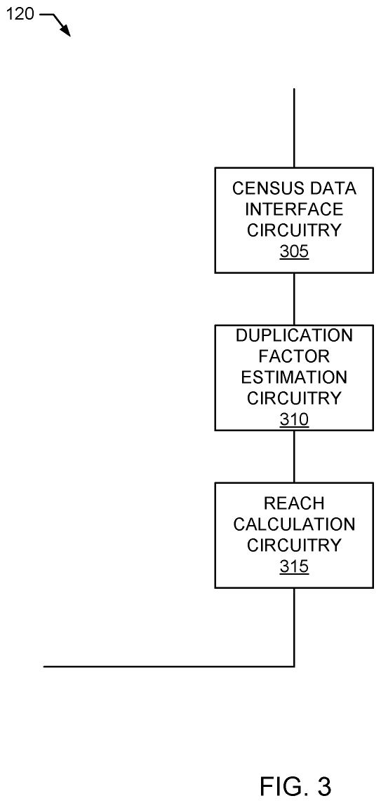

A block diagram of a second example implementation of the population reach determination circuitry 120, which is based on Fréchet inequalities, is illustrated in FIG. 3. The example population reach determination circuitry 120 of FIG. 3 includes example census data interface circuitry 305, example duplication factor estimation circuitry 315 and example reach calculation circuitry 320. In contrast with the example of FIG. 2, the example population reach determination circuitry 120 of FIG. 3 does not utilize panel data to estimate the duplication factor. Not relying on panel data can be beneficial when the panel data is unavailable or does not completely cover the media segments (e.g., individual programs, device brands, websites, etc.) of interest. Rather than utilizing panel data, the example population reach determination circuitry 120 of FIG. 3 utilizes a regression model to estimate (e.g., predict) predict a parameter (e.g., a duplication factor) for a deduplication model that ensures logical consistency, and which can be used to de-duplicate audience measurements.

Two example implementations of the population reach determination circuitry 120 of FIG. 3 are disclosed. Both example implementations are based on the following. Let Xᵢ represent the set of census marginal audiences (or census marginal ratings values) to be de-duplicated, and let X_{d} represent the estimated de-duplicated audience (or census reach value). The population reach determination circuitry 120 of FIG. 3 is designed to ensure the logical consistencies of Equation 13 are maintained:

$$1. max ( {X}_{i} ) \leq {X}_{d} \leq min ( U E , {\sum }_{i} {X}_{i} ) \\ 2. {X}_{d} \leq UE \qquad Equation 13$$

In Equation 13, UE represents the size, or universe estimate, of the census population of interest.

A first example implementation of the population reach determination circuitry 120 of FIG. 3 utilizes the Fréchet-based duplication factor, r, of Equation 8, which rewritten using the notation of Equation 13 is given by Equation 14:

$$r = \frac{{X}_{d} - max ( {X}_{i} )}{min ( UE , {\sum }_{i} {X}_{i} ) - max ( {X}_{i} )} \qquad Equation 14$$

The population reach determination circuitry 120 of FIG. 3 operates to predict the duplication factor, r, using a double exponential regression model of the form given by Equation 15:

y=a·exp(b·x)+c·exp(d·x) Equation 15

In the illustrated example, the population reach determination circuitry 120 sets the independent variable x of the regression model of Equation 15 to be log(min(UE, ΣᵢXᵢ)−max (Xᵢ)), and sets the dependent variable y of the regression model of Equation 15 to be log(r). In the illustrated example, the population reach determination circuitry 120 of FIG. 3 accesses historical census marginal ratings values (e.g., historical values of Xᵢ) for a set of historical time intervals to compute historical values of the regression model's independent variable x for the set of historical time intervals. In the illustrated example, the population reach determination circuitry 120 of FIG. 3 accesses historical census reach values (e.g., historical values of X_{d}) and/or historical values of the duplication factor (e.g., historical values of r) for the set of historical time intervals to compute historical values of the regression model's dependent variable y for the set of historical time intervals. In the illustrated example, the population reach determination circuitry 120 of FIG. 3 then performs a regression analysis using the computed historical values of the regression model's independent variable x and dependent variable y to determine the parameter values (e.g., a, b, c, d) of the double exponential model of Equation 15. In some examples, the population reach determination circuitry 120 of FIG. 3 builds different versions of the double exponential model of Equation 15 for different demographic groups, as well as a version of the double exponential model of Equation 15 for the combination of the demographic groups. The population reach determination circuitry 120 of FIG. 3 then saves the parameter values (e.g., a, b, c, d) of the double exponential model(s) for use when inferring the duplication factor for a current inference time interval.

At inference time, the saved parameter values (e.g., a, b, c, d) for the double exponential model(s) (e.g., for the different demographic groups and/or the combination of the demographic groups) are used by the population reach determination circuitry 120 of FIG. 3 to predict the Frechet-based duplication factor as \hat{r}_{f}=exp (ŷ), where ŷ is computed according to Equation 15, with the independent variable, x, computed from the census marginal ratings values (e.g., Xᵢ) for the current inference time interval.

Given the predicted Frechet-based duplication factor \hat{r}_{f}, the population reach determination circuitry 120 of FIG. 3 predicts the de-duplicated audience (or census reach value) based on Equation 12, which using the above notation can be rewritten as Equation 16:

$${\hat{X}}_{d} = {\hat{r}}_{f} \cdot ( min ( UE , {\sum }_{i} {X}_{i} ) - max ( {X}_{i} ) ) + max ( {X}_{i} ) \qquad Equation 16$$

A caveat of this first example implementation of the population reach determination circuitry 120 of FIG. 3 is that it does not necessarily guarantee the second logical consistency mentioned above, i.e., X_{d}≤UE. However, this can be solved by capping the predicted de-duplicated audience (or the census reach value) to be no greater than the universe estimate (or universe estimates for the different demographic groups).

A second example implementation of the population reach determination circuitry 120 of FIG. 3 builds a maximum entropy model using historical census data, uses a regression model to predict a model parameter at inference time, and recovers the de-duplicated audience (or census reach value) using the predicted parameter. Suppose that a reference marginal audiences (or reference marginal ratings values), denoted Aᵢ, and de-duplicated reference audience, denoted A_{d}, which are both normalized by the universe estimate, are related by Equation 17, which is:

$$1 - \frac{{A}_{d}}{Q} = {\prod }_{i} ( 1 - \frac{{A}_{i}}{Q} ) \qquad Equation 17$$

In Equation 17, Q is a parameter that can be solved given the Aᵢ values and the A_{d} value. Given a solved value of Q, a parameter r can be calculated according to Equation 18:

$$r = \frac{Q - {A}_{d}}{1 - {A}_{d}} \qquad Equation 18$$

The parameter r can be transformed into a parameter r′ according to Equation 19:

$${r}^{′} = \frac{1 - r}{1 + r} \qquad Equation 19$$

The parameter r′ of Equation 19 is bounded by the interval [−1, +1]. The parameter r′ can be further transformed into a parameter r* according to Equation 20:

$${r}^{*} = \frac{{r}^{′} + 1}{2} \qquad Equation 20$$

The parameter r* of Equation 20 is bounded by the interval [0, 1]. With r*=0, the set of marginal audiences (or marginal ratings) will be completely overlapping, such that the de-duplicated audience (or reach) is the same as the maximum of the set. With r*=1, the set of marginal audiences (or marginal ratings) will be completely disjoint, such that the de-duplicated audience (or reach) is the same as the sum of the set of marginal audiences (or sum of the marginal ratings). It can be seen that r* has a similar meaning as the Frechet-based duplication factor at the two extreme ends of its value.

Similar to the first example implementation described above, the second example implementation of the population reach determination circuitry 120 of FIG. 3 uses a regression model to predict the value of r*, based on the independent variable min(UE, ΣᵢXᵢ)−max (Xᵢ). The second example implementation of the population reach determination circuitry 120 of FIG. 3 fits the relationship at the log transformed scale with a 2nd order polynomial. the population reach determination circuitry 120 of FIG. 3 builds different versions of the double exponential model of Equation 15 for different demographic groups, as well as a version of the double exponential model of Equation 15 for the combination of the demographic groups. The population reach determination circuitry 120 of FIG. 3 then saves the parameter values (e.g., a, b, c, d) of the double exponential model(s) for use when inferring the duplication factor r* for a current inference time interval.

At inference time, the second example implementation of the population reach determination circuitry 120 of FIG. 3 predicts then duplication factor \hat{r}* by evaluating the regression model using the stored parameter values (e.g., a, b, c, d) (and, in some examples, for each demographic). The second example implementation of the population reach determination circuitry 120 of FIG. 3 then recovers the value of by reversing the transformation according to Equation 21 and Equation 22:

$$\begin{matrix}{\hat{r}}^{′} = 2 {\hat{r}}^{*} - 1 & Equation 21 \\ \hat{r} = \frac{1 - {\hat{r}}^{′}}{1 + {\hat{r}}^{′}} & Equation 22\end{matrix}$$

Next, the second example implementation of the population reach determination circuitry 120 of FIG. 3 estimates the de-duplicated audience (or census reach value) by solving an example system of equations given by Equation 23 and Equation 24, which are:

$$\begin{matrix}1 - \frac{{X}_{d}}{{Q}_{x}} = {\prod }_{i} ( 1 - \frac{{X}_{i}}{{Q}_{x}} ) & Equation 23 \\ {X}_{d} = \frac{{Q}_{x} - \hat{r}}{1 - \hat{r}} & Equation 24\end{matrix}$$

In Equations 23 and 24, the values of Xᵢ correspond to the census marginal ratings values (or marginal audiences) for the current inference interval for which the marginal reach (or de-duplicated audience) X_{d} is being determined.

In some examples, if the regression model predicted a value of the duplication factor \hat{r}* that is outside the bounds [0, 1], then the second example implementation of the population reach determination circuitry 120 of FIG. 3 clips the value of \hat{r}* such that it lies within the bounds [0, 1].

With the foregoing in mind, the example population reach determination circuitry 120 of FIG. 3 includes the example census data interface circuitry 305 to access the RPD audience storage 116 to obtain the census marginal ratings values (e.g., the set of census Xᵢ values for the media segments) for a given census population being associated with (e.g., exposed to, accessed, used, etc.) the group of media segments, and for a current inference interval and one or more historical (or prior) time intervals. In some examples, the example census data interface circuitry 305 also accesses the RPD audience storage 116 to obtain historical reach values (e.g., historical values of X_{d} or A_{d} described above) and/or historical duplication factors (e.g., historical values of r or \hat{r}* described above) for the one or more historical (or prior) time intervals.

The example population reach determination circuitry 120 of FIG. 3 includes the example duplication factor estimation circuitry 315 to estimate a duplication factor (e.g., r or \hat{r}*) based on a double exponential regression model, as described above. For example, the duplication factor estimation circuitry 315 of the illustrated example performs a regression analysis with an independent variable (e.g., x) based on a difference between the sum of the marginal ratings values and the largest one of the first marginal ratings values (e.g., min(UE, ΣᵢXᵢ)−max (Xᵢ)), and a dependent variable (e.g., y) based on a historical reach value (e.g., historical values of X_{d} or A_{d} described above) to determine parameter values (e.g., a, b, c, d) of the double exponential model (e.g., y=a·exp(b·x)+c·exp(d·x)).

The example population reach determination circuitry 120 of FIG. 3 includes the example reach calculation circuitry 320 to calculate and output a census reach value. In the first example implementation of the population reach determination circuitry 120 of FIG. 3, the reach calculation circuitry 320 outputs the census reach value (\hat{X}_{d}) based on Equation 16. Thus, the reach calculation circuitry 320 of the first example implementation calculates and outputs the panel reach value (e.g., \hat{X}_{d}) based on the duplication factor, \hat{r}_{f}, estimated by the duplication factor estimation circuitry 315 and the census marginal ratings values (e.g., the set of census Xᵢ values) for the union of media segments and for the current inference time interval. More specifically, and with reference to Equation 16, in the first example implementation, the reach calculation circuitry 320 determines a difference (e.g., min(UE, ΣᵢXᵢ)−max(Xᵢ)) between a sum of the census marginal ratings values (e.g., min(UE, ΣᵢXᵢ)) and a largest one of the census marginal ratings values (e.g., max (Xᵢ)). The reach calculation circuitry 320 of the illustrated example then adds the largest one of the census marginal ratings values (e.g., max (Xᵢ)) to a product of the computed difference (e.g., min(UE, ΣᵢXᵢ)−max(Xᵢ)) and the duplication factor (e.g., \hat{r}_{f}) to determine the census reach value (e.g., \hat{X}_{d}) for the union of the media segments.

In the second example implementation of the population reach determination circuitry 120 of FIG. 3, the reach calculation circuitry 320 outputs the census reach value (\hat{X}_{d}) based on solving the system of equations given by Equations 23 and Equations 24. With reference to Equations 23 and Equations 24, the system of equations is based on the duplication factor (e.g., \hat{r}*, which is used to compute \hat{r}) and the census marginal ratings values (.g., max (Xᵢ)).

In some examples, the population reach determination circuitry 120 of FIG. 3 includes means for estimating a duplication factor. For example, the means for estimating the duplication factor may be implemented by example duplication factor estimation circuitry 315. In some examples, the duplication factor estimation circuitry 315 may be implemented by machine executable instructions such as that implemented by at least blocks 610, 705, 710, 715, 720, 725, 805, 810, 815, 820, 825 and/or 830 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the duplication factor estimation circuitry 315 is implemented by other hardware logic circuitry, hardware implemented state machines, and/or any other combination of hardware, software, and/or firmware. For example, the duplication factor estimation circuitry 315 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the population reach determination circuitry 120 of FIG. 3 includes means for means for outputting a reach value. For example, the means for outputting the reach value may be implemented by example reach calculation circuitry 320. In some examples, the reach calculation circuitry 320 may be implemented by machine executable instructions such as that implemented by at least blocks 620 and/or 625 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the reach calculation circuitry 320 is implemented by other hardware logic circuitry, hardware implemented state machines, and/or any other combination of hardware, software, and/or firmware. For example, the reach calculation circuitry 320 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the population reach determination circuitry 120 is illustrated in FIGS. 1-3, one or more of the elements, processes, and/or devices illustrated in FIGS. 1-3 may be combined, divided, re-arranged, omitted, eliminated, and/or implemented in any other way. Further, the example census data interface circuitry 205, the example panel data interface circuitry 210, the example duplication factor estimation circuitry 215, the example reach calculation circuitry 220, the example census data interface circuitry 305, the example duplication factor estimation circuitry 315, the example reach calculation circuitry 320 and/or, more generally, the example population reach determination circuitry 120 of FIGS. 1-3, may be implemented by hardware, software, firmware, and/or any combination of hardware, software, and/or firmware. Thus, for example, any of the example census data interface circuitry 205, the example panel data interface circuitry 210, the example duplication factor estimation circuitry 215, the example reach calculation circuitry 220, the example census data interface circuitry 305, the example duplication factor estimation circuitry 315, the example reach calculation circuitry 320 and/or, more generally, the example population reach determination circuitry 120 could be implemented by processor circuitry, analog circuit(s), digital circuit(s), logic circuit(s), programmable processor(s), programmable microcontroller (s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)) such as Field Programmable Gate Arrays (FPGAs). When reading any of the apparatus or system claims of this patent to cover a purely software and/or firmware implementation, at least one of the example population reach determination circuitry 120, the example census data interface circuitry 205, the example panel data interface circuitry 210, the example duplication factor estimation circuitry 215, the example reach calculation circuitry 220, the example census data interface circuitry 305, the example duplication factor estimation circuitry 315 and/or the example reach calculation circuitry 320 is/are hereby expressly defined to include a non-transitory computer readable storage device or storage disk such as a memory, a digital versatile disk (DVD), a compact disk (CD), a Blu-ray disk, etc. including the software and/or firmware. Further still, the example population reach determination circuitry 120 may include one or more elements, processes and/or devices in addition to, or instead of, those illustrated in FIGS. 1-3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

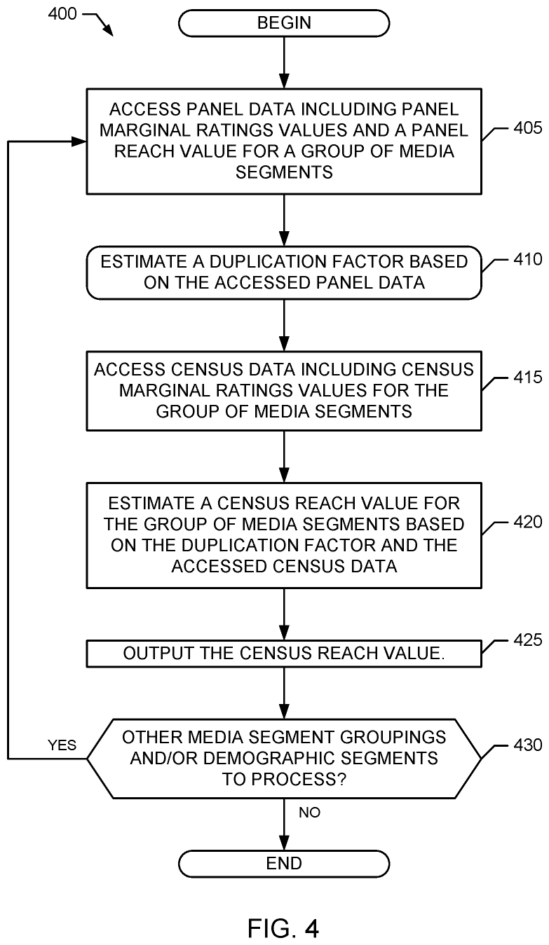

Flowcharts representative of example hardware logic circuitry, machine readable instructions, hardware implemented state machines, and/or any combination thereof for implementing the population reach determination circuitry 120 are shown in FIGS. 4-8. In these examples, the machine readable instructions may be one or more executable programs or portion(s) of an executable program for execution by a computer processor and/or processor circuitry, such as the processor circuitry 912 shown in the example processor platform 900 discussed below in connection with FIG. 9 and/or the example processor circuitry discussed below in connection with FIGS. 10 and/or 11. The one or more programs, or portion(s) thereof, may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program or programs and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 4-8, many other methods of implementing the example population reach determination circuitry 120 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

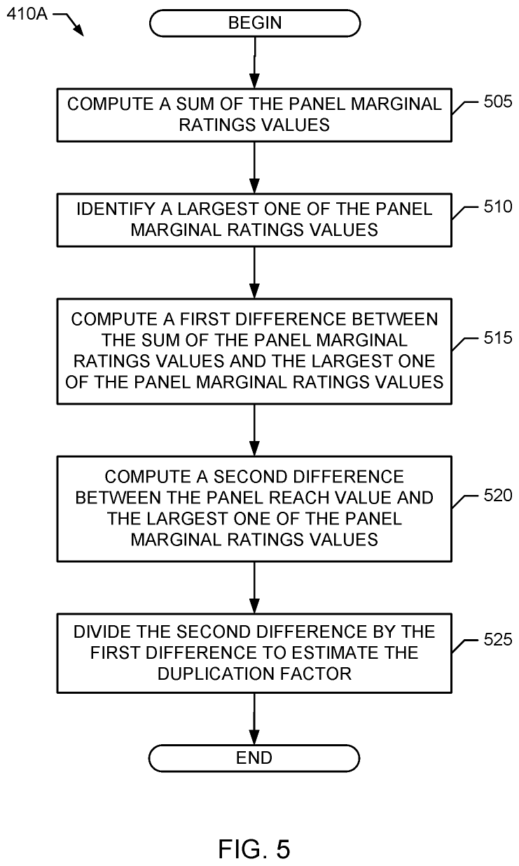

FIG. 4 is a flowchart representative of example machine readable instructions and/or example operations 400 that may be executed and/or instantiated by processor circuitry to implement the example population reach determination circuitry 120 of FIGS. 1 and/or 2. With reference to the preceding figures and associated written descriptions, the machine readable instructions and/or operations 400 of FIG. 4 begin at block 405, at which the example panel data interface circuitry 210 of the population reach determination circuitry 120 accesses the panelist data storage 118 to obtain panel data including panel marginal ratings values and a panel marginal reach value for a group of media segments, as described above. At block 410, the example duplication factor estimation circuitry 215 of the population reach determination circuitry 120 estimates, as described above, a duplication factor based on the panel data accessed at block 405. For example, the duplication factor estimation circuitry 215 may estimate the duplication factor according to Equation 6, as described above. Example machine readable instructions and/or example operations that may be executed and/or instantiated by processor circuitry to implement the processing at block 410 are illustrated in FIG. 5, which is described in further detail below.

At block 415, the example census data interface circuitry 205 of the population reach determination circuitry 120 accesses the RPD audience storage 116 to obtain census marginal ratings values for the group of media segments, as described above. At block 420, the example reach calculation circuitry 220 of the population reach determination circuitry 120 estimates, as described above, a census reach value for the union of the group of media segments based on the duplication factor determined at block 410 and the census marginal ratings values. For example, the reach calculation circuitry 220 may estimate the census reach value according to Equation 12, as described above. At block 425, the reach calculation circuitry 220 outputs the estimated census reach value. At block 430, the population reach determination circuitry 120 determines whether census reach values for other media segment groupings and/or demographic segments are to be estimated. If yes, then processing returns to block 405. Otherwise, the machine readable instructions and/or operations 400 end.

FIG. 5 is a flowchart representative of example machine readable instructions and/or example operations 410A that may be executed and/or instantiated by processor circuitry to implement the processing at block 410 of FIG. 4. With reference to the preceding figures and associated written descriptions, the machine readable instructions and/or operations 410A of FIG. 5 begin at block 505, at which the duplication factor estimation circuitry 215 of the population reach determination circuitry 120 computes a sum of the panel marginal ratings values, as described above. At block 510, the duplication factor estimation circuitry 215 selects a largest one of the panel marginal ratings values. At block 515, the duplication factor estimation circuitry 215 computes a first difference between the sum of the panel marginal ratings values and the largest one of the panel marginal ratings values. At block 520, the duplication factor estimation circuitry 215 computes a second difference the panel reach value and the largest one of the panel marginal ratings values. At block 525, the duplication factor estimation circuitry 215 divides the second difference by the first difference to estimate the duplication factor. The machine readable instructions and/or operations 410A then end.

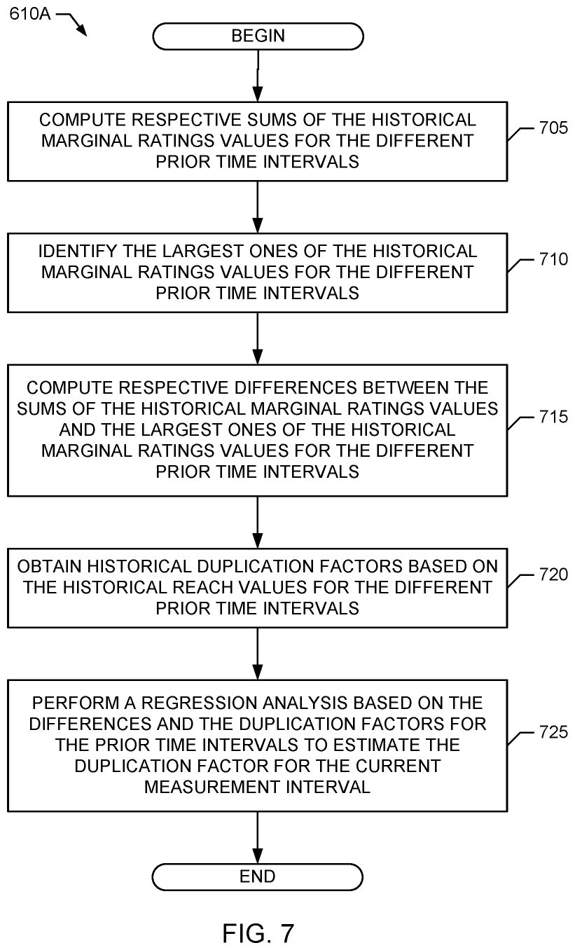

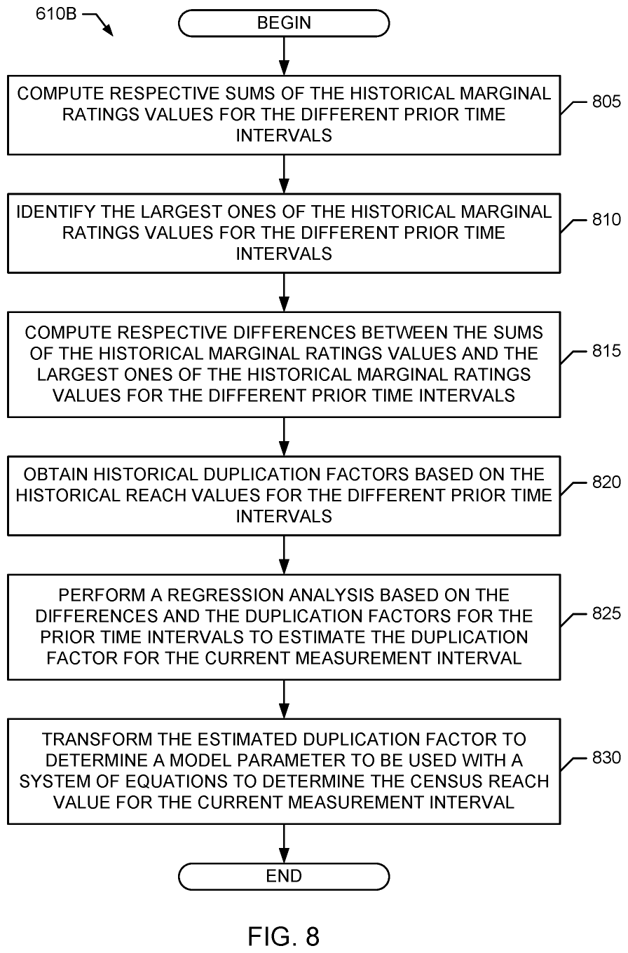

FIG. 6 is a flowchart representative of example machine readable instructions and/or example operations 600 that may be executed and/or instantiated by processor circuitry to implement the example population reach determination circuitry 120 of FIGS. 1 and/or 3. With reference to the preceding figures and associated written descriptions, the machine readable instructions and/or operations 600 of FIG. 6 begin at block 605, at which the example census data interface circuitry 305 of the population reach determination circuitry 120 accesses the RPD audience storage 116 to obtain historical census data including historical census marginal ratings values and historical census reach values for a group of media segments and for one or more historical time intervals prior to a current inference time interval, as described above. At block 610, the example duplication factor estimation circuitry 315 of the population reach determination circuitry 120 estimates, as described above, a duplication factor based on the historical census data accessed at block 605. In some examples, the duplication factor estimation circuitry 215 may estimate the duplication factor using a double exponential regression model, as described above. First example machine readable instructions and/or example operations that may be executed and/or instantiated by processor circuitry to implement the processing at block 610 are illustrated in FIG. 7, which is described in further detail below. Second example machine readable instructions and/or example operations that may be executed and/or instantiated by processor circuitry to implement the processing at block 610 are illustrated in FIG. 8, which is described in further detail below.

At block 615, the example census data interface circuitry 305 accesses the RPD audience storage 116 to obtain historical census data including census marginal ratings values for the group of media segments and for the current inference time interval, as described above. At block 620, the example reach calculation circuitry 320 of the population reach determination circuitry 120 estimates, as described above, a census reach value for the union of the group of media segments based on the duplication factor determined at block 610 and the census marginal ratings values for the current inference interval. In some examples, the reach calculation circuitry 320 may estimate the census reach value according to Equation 16, as described above. In some examples, the reach calculation circuitry 320 may estimate the census reach value by solving an the system of equations given by Equation 23 and Equation 24, as described above. At block 625, the reach calculation circuitry 320 outputs the estimated census reach value. At block 630, the population reach determination circuitry 120 determines whether census reach values for other media segment groupings and/or demographic segments are to be estimated. If yes, then processing returns to block 605. Otherwise, the machine readable instructions and/or operations 600 end.

FIG. 7 is a flowchart representative of first example machine readable instructions and/or example operations 610A that may be executed and/or instantiated by processor circuitry to implement the processing at block 610 of FIG. 6. With reference to the preceding figures and associated written descriptions, the machine readable instructions and/or operations 610A of FIG. 7 begin at block 705, at which the duplication factor estimation circuitry 315 of the population reach determination circuitry 120 computes respective sums of the historical census marginal ratings values for the different historical/prior time intervals to be used in the regression analysis, as described above. At block 710, the duplication factor estimation circuitry 315 identifies the largest one of the historical census marginal ratings values for each one of the different historical/prior time intervals, as described above. At block 715, the duplication factor estimation circuitry 315 computes respective differences between (i) the respective sums of the historical census marginal ratings values for the different historical/prior time intervals and (ii) the largest ones of the historical census marginal ratings values for the different historical/prior time intervals. At block 720, the duplication factor estimation circuitry 315 obtains historical duplication factors based on the historical reach values obtained for the different historical/prior time intervals. For example, at block 720, the duplication factor estimation circuitry 315 may evaluate Equation 14 using the historical marginal ratings values and reach values for the different historical/prior time intervals to determine the historical duplication factors for the different historical/prior time intervals. At block 725, the duplication factor estimation circuitry 315 performs a regression analysis, as described above, based on the differences determined at block 715 and the historical duplication factors determined at block 720 to estimate the duplication factor for the current inference time interval. For example, at block 725, the duplication factor estimation circuitry 315 may perform the regression analysis described above in connection with Equation 14 through Equation 16. The machine readable instructions and/or operations 610A then end.

FIG. 8 is a flowchart representative of second example machine readable instructions and/or example operations 610B that may be executed and/or instantiated by processor circuitry to implement the processing at block 610 of FIG. 6. With reference to the preceding figures and associated written descriptions, the machine readable instructions and/or operations 610B of FIG. 8 begin at block 805, at which the duplication factor estimation circuitry 315 of the population reach determination circuitry 120 computes respective sums of the historical census marginal ratings values for the different historical/prior time intervals to be used in the regression analysis, as described above. At block 810, the duplication factor estimation circuitry 315 identifies the largest one of the historical census marginal ratings values for each one of the different historical/prior time intervals, as described above. At block 815, the duplication factor estimation circuitry 315 computes respective differences between (i) the respective sums of the historical census marginal ratings values for the different historical/prior time intervals and (ii) the largest ones of the historical census marginal ratings values for the different historical/prior time intervals. At block 820, the duplication factor estimation circuitry 315 obtains historical duplication factors based on the historical reach values obtained for the different historical/prior time intervals. For example, at block 820, the duplication factor estimation circuitry 315 may evaluate Equation 14 using the historical marginal ratings values and reach values for the different historical/prior time intervals to determine the historical duplication factors for the different historical/prior time intervals. At block 825, the duplication factor estimation circuitry 315 performs a regression analysis, as described above, based on the differences determined at block 815 and the historical duplication factors determined at block 820 to estimate the duplication factor for the current inference time interval. For example, at block 725, the duplication factor estimation circuitry 315 may perform the regression analysis described above in connection with Equation 17 through Equation 22. At block 830, the duplication factor estimation circuitry 315 transforms the estimated duplication factor obtained at block 825 to determine a model parameter to be used with a system of equations to determine the census reach value for the current inference time interval. For example, at block 830, the duplication factor estimation circuitry 315 may solve the system of Equations 23 and 24, as described above, to estimate the census reach value for the current inference time interval. The machine readable instructions and/or operations 610A then end.

FIG. 9 is a block diagram of an example processor platform 900 structured to execute and/or instantiate the machine readable instructions and/or operations of FIGS. 4, 5, 6, 7 and/or 8 to implement the example population reach determination circuitry 120 of FIGS. 1-3. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, etc., or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor 912 may be a semiconductor based (e.g., silicon based) device. In this example, the processor 912 implements the population reach determination circuitry 120 and, thus, may implement one or more of the example census data interface circuitry 205, the example panel data interface circuitry 210, the example duplication factor estimation circuitry 215, the example reach calculation circuitry 220, the example census data interface circuitry 305, the example duplication factor estimation circuitry 315, the example reach calculation circuitry 320.

The processor 912 of the illustrated example includes a local memory 913 (e.g., a cache, registers, etc.). The processor circuitry 912 of the illustrated example is in communication with a main memory including a volatile memory 914 and a non-volatile memory 916 via a link 918. The link 918 may be implemented by a bus, one or more point-to-point connections, etc., or a combination thereof. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 922 are connected to the interface circuitry 920. The input device(s) 922 permit(s) a user to enter data and/or commands into the processor circuitry 912. The input device(s) can be implemented by, for example, an audio sensor, a microphone, a camera (still or video), a keyboard, a button, a mouse, a touchscreen, a track-pad, a trackball, a trackbar (such as an isopoint device), a voice recognition system and/or any other human-machine interface. Also, many systems, such as the processor platform 900, can allow the user to control the computer system and provide data to the computer using physical gestures, such as, but not limited to, hand or body movements, facial expressions, and face recognition.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer and/or speakers(s). The interface circuitry 920 of the illustrated example, thus, typically includes a graphics driver card, a graphics driver chip and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be via, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932 which may be implemented by the machine readable instructions of FIGS. 4, 5, 6, 7 and/or 8 may be stored in the mass storage device 928, in the volatile memory 914, in the non-volatile memory 916, in the local memory 913 and/or on a removable non-transitory computer readable storage medium, such as a CD or DVD 936.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 4, 5, 6, 7 and/or 8.

The cores 1002 may communicate by an example bus 1004. In some examples, the bus 1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1020 may implement at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1100 of FIG. 10 described above (which is a general purpose device that may be programmed to execute some or all of the machine readable instructions represented by the flowchart of FIGS. 4, 5, 6, 7 and/or 8, but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowchart of FIGS. 4, 5, 6, 7 and/or 8. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 4, 5, 6, 7, and/or 8. As such, the FPGA circuitry 1100 may be structured to effectively instantiate some or all of the machine readable instructions of the flowcharts of FIGS. 4, 5, 6, 7, and/or 8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 4, 5, 6, 7, and/or 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1100 of FIG. 5. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIGS. 4, 5, 6, 7 and/or 8, and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 6 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 4, 5, 6, 7 and/or 8 may be executed by one or more of the cores 1002 of FIG. 10 and a second portion of the machine readable instructions represented by the flowchart of FIGS. 4, 5, 6, 7 and/or 8 may be executed by the FPGA circuitry 1100 of FIG. 11.

In some examples, the processor circuitry 912 of FIG. 9 may be in one or more packages. For example, the processor circuitry 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

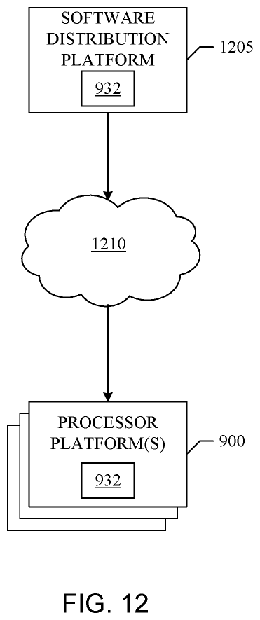

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 4, 5, 6, 7 and/or 8, as described above. The one or more servers of the example software distribution platform 1205 are in communication with a network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 4, 5, 6, 7 and/or 8, may be downloaded to the example processor platform 900, which is to execute the machine readable instructions 932 to implement the example population reach determination circuitry 120. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that estimate and use duplication factors for audience measurement. The disclosed systems, methods, apparatus, and articles of manufacture improve the efficiency of using a computing device by estimation duplication factors and using the duplication factors to determine de-duplicated population reach values in a manner that satisfies logical constraints, thereby preventing the output of impossible reach values. By preventing the output of impossible reach values, the disclosed systems, methods, apparatus, and articles of manufacture can prevent downstream processing systems from crashing or performing error handling that may result from impossible reach values being input to those downstream processing systems. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to estimate and use duplication factors for audience measurement are disclosed herein. The following further examples are disclosed herein. The disclosed examples can be implemented individually and/or in one or more combinations.

Example 1 includes an apparatus to estimate a duplication factor, the apparatus comprising at least one memory, instructions in the apparatus, and processor circuitry to execute the instructions to at least access first marginal ratings values for a plurality of media segments, respective ones of the first marginal ratings values to represent respective portions of a first population associated with corresponding ones of the media segments, estimate the duplication factor based on a difference between a sum of the first marginal ratings values and a largest one of the first marginal ratings values, access second marginal ratings values for the plurality of media segments, respective ones of the second marginal ratings values to represent respective portions of a second population associated with corresponding ones of the media segments, and output, based on the duplication factor and the second marginal ratings values, a reach value for a union of the media segments, the reach value to represent a number of unique individuals of the second population associated with at least one of the media segments.

Example 2 includes the apparatus of example 1, wherein the reach value is a second reach value, and the processor circuitry is to access a first reach value for the union of media segments, the first reach value to represent a number of unique individuals of the first population associated with at least one of the media segments, and estimate the duplication factor based on the first reach value and the difference between the sum of the marginal ratings values and the largest one of the first marginal ratings values.

Example 3 includes the apparatus of example 2, wherein to estimate the duplication factor, the processor circuitry is to subtract the largest one of the first marginal ratings values from the first reach value to determine a difference value, and divide the difference value by the difference between the sum of the marginal ratings values and the largest one of the first marginal ratings values to determine the duplication factor.

Example 4 includes the apparatus of example 1, wherein the first population corresponds to a historical version of the second population, the first population associated with a first interval prior to a second time interval of the second population, the reach value is a second reach value, and the processor circuitry is to access a first reach value for the union of media segments, the first reach value to represent a number of unique individuals of the first population associated with at least one of the media segments, and estimate the duplication factor based on the first reach value and the difference between the sum of the marginal ratings values and the largest one of the first marginal ratings values.

Example 5 includes the apparatus of example 4, wherein the processor circuitry is to perform a regression analysis with an independent variable based on the difference and a dependent variable based on the first reach value to determine parameter values of a double exponential model, and evaluate the double exponential model based on the parameter values and the second marginal ratings values to estimate the duplication factor.

Example 6 includes the apparatus of example 4, wherein the processor circuitry is to perform a regression analysis based on the difference and the first reach value to estimate the duplication factor, and solve a system of equations to determine the second reach value, the system of equations based on the duplication factor and the second marginal ratings values.

Example 7 includes the apparatus of example 1, wherein the difference is a first difference, and the processor circuitry is to determine a second difference between a sum of the second marginal ratings values and a largest one of the second marginal ratings values, and add the largest one of the second marginal ratings values to a product of the second difference and the duplication factor to determine the reach value.

Example 8 includes at least one non-transitory computer readable medium comprising computer readable instructions that, when executed, cause at least one processor to at least access first marginal ratings values for a plurality of media segments, respective ones of the first marginal ratings values to represent respective portions of a first population associated with corresponding ones of the media segments, estimate a duplication factor based on a difference between a sum of the first marginal ratings values and a largest one of the first marginal ratings values, access second marginal ratings values for the plurality of media segments, respective ones of the second marginal ratings values to represent respective portions of a second population associated with corresponding ones of the media segments, and output, based on the duplication factor and the second marginal ratings values, a reach value for a union of the media segments, the reach value to represent a number of unique individuals of the second population associated with at least one of the media segments.

Example 9 includes the at least one non-transitory computer readable medium of example 8, wherein the reach value is a second reach value, and the instructions cause the at least one processor to access a first reach value for the union of media segments, the first reach value to represent a number of unique individuals of the first population associated with at least one of the media segments, and estimate the duplication factor based on the first reach value and the difference between the sum of the marginal ratings values and the largest one of the first marginal ratings values.

Example 10 includes the at least one non-transitory computer readable medium of example 9, wherein to estimate the duplication factor, the instructions cause the at least one processor to subtract the largest one of the first marginal ratings values from the first reach value to determine a difference value, and divide the difference value by the difference between the sum of the marginal ratings values and the largest one of the first marginal ratings values to determine the duplication factor.

Example 11 includes the at least one non-transitory computer readable medium of example 8, wherein the first population corresponds to a historical version of the second population, the first population associated with a first interval prior to a second time interval of the second population, the reach value is a second reach value, and the instructions cause the at least one processor to access a first reach value for the union of media segments, the first reach value to represent a number of unique individuals of the first population associated with at least one of the media segments, and estimate the duplication factor based on the first reach value and the difference between the sum of the marginal ratings values and the largest one of the first marginal ratings values.

Example 12 includes the at least one non-transitory computer readable medium of example 11, wherein the instructions cause the at least one processor to perform a regression analysis with an independent variable based on the difference and a dependent variable based on the first reach value to determine parameter values of a double exponential model, and evaluate the double exponential model based on the parameter values and the second marginal ratings values to estimate the duplication factor.

Example 13 includes the at least one non-transitory computer readable medium of example 11, wherein the instructions cause the at least one processor to perform a regression analysis based on the difference and the first reach value to estimate the duplication factor, and solve a system of equations to determine the second reach value, the system of equations based on the duplication factor and the second marginal ratings values.

Example 14 includes the at least one non-transitory computer readable medium of example 8, wherein the difference is a first difference, and the instructions cause the at least one processor to determine a second difference between a sum of the second marginal ratings values and a largest one of the second marginal ratings values, and add the largest one of the second marginal ratings values to a product of the second difference and the duplication factor to determine the reach value.

Example 15 includes a method to estimate a duplication factor, the method comprising accessing first marginal ratings values for a plurality of media segments, respective ones of the first marginal ratings values to represent respective portions of a first population associated with corresponding ones of the media segments, estimating, by executing an instructions with at least one processor, a duplication factor based on a difference between a sum of the first marginal ratings values and a largest one of the first marginal ratings values, accessing second marginal ratings values for the plurality of media segments, respective ones of the second marginal ratings values to represent respective portions of a second population associated with corresponding ones of the media segments, and outputting, based on the duplication factor and the second marginal ratings values, a reach value for a union of the media segments, the reach value to represent a number of unique individuals of the second population associated with at least one of the media segments.

Example 16 includes the method of example 15, wherein the reach value is a second reach value, and further including accessing a first reach value for the union of media segments, the first reach value to represent a number of unique individuals of the first population associated with at least one of the media segments, and estimating the duplication factor based on the first reach value and the difference between the sum of the marginal ratings values and the largest one of the first marginal ratings values.

Example 17 includes the method of example 16, wherein the estimating of the duplication factor includes subtracting the largest one of the first marginal ratings values from the first reach value to determine a difference value, and dividing the difference value by the difference between the sum of the marginal ratings values and the largest one of the first marginal ratings values to determine the duplication factor.

Example 18 includes the method of example 15, wherein the first population corresponds to a historical version of the second population, the first population associated with a first interval prior to a second time interval of the second population, the reach value is a second reach value, and further including accessing a first reach value for the union of media segments, the first reach value to represent a number of unique individuals of the first population associated with at least one of the media segments, and estimating the duplication factor based on the first reach value and the difference between the sum of the marginal ratings values and the largest one of the first marginal ratings values.

Example 19 includes the method of example 18, wherein the estimating of the duplication factor includes performing a regression analysis with an independent variable based on the difference and a dependent variable based on the first reach value to determine parameter values of a double exponential model, and evaluating the double exponential model based on the parameter values and the second marginal ratings values to estimate the duplication factor.

Example 20 includes the method of example 18, wherein the estimating of the duplication factor includes performing a regression analysis based on the difference and the first reach value to estimate the duplication factor, and solving a system of equations to determine the second reach value, the system of equations based on the duplication factor and the second marginal ratings values.

Example 21 includes the method of example 15, wherein the difference is a first difference, and further including determining a second difference between a sum of the second marginal ratings values and a largest one of the second marginal ratings values, and adding the largest one of the second marginal ratings values to a product of the second difference and the duplication factor to determine the reach value.

Example 22 includes an apparatus to estimate a duplication factor, the apparatus comprising means for accessing first marginal ratings values for a plurality of media segments, respective ones of the first marginal ratings values to represent respective portions of a first population associated with corresponding ones of the media segments, means for estimating the duplication factor based on a difference between a sum of the first marginal ratings values and a largest one of the first marginal ratings values, means for accessing second marginal ratings values for the plurality of media segments, respective ones of the second marginal ratings values to represent respective portions of a second population associated with corresponding ones of the media segments, and means for outputting, based on the duplication factor and the second marginal ratings values, a reach value for a union of the media segments, the reach value to represent a number of unique individuals of the second population associated with at least one of the media segments.

Example 23 includes the apparatus of example 22, wherein the reach value is a second reach value, the means for accessing the first marginal ratings values is to access a first reach value for the union of media segments, the first reach value to represent a number of unique individuals of the first population associated with at least one of the media segments, and the means for estimating is to estimate the duplication factor based on the first reach value and the difference between the sum of the marginal ratings values and the largest one of the first marginal ratings values.

Example 24 includes the apparatus of example 23, wherein to estimate the duplication factor, the means for estimating is to subtract the largest one of the first marginal ratings values from the first reach value to determine a difference value, and divide the difference value by the difference between the sum of the marginal ratings values and the largest one of the first marginal ratings values to determine the duplication factor.

Example 25 includes the apparatus of example 22, wherein the first population corresponds to a historical version of the second population, the first population associated with a first interval prior to a second time interval of the second population, the reach value is a second reach value, and the means for accessing the first marginal ratings values is to access a first reach value for the union of media segments, the first reach value to represent a number of unique individuals of the first population associated with at least one of the media segments, and the means for estimating is to estimate the duplication factor based on the first reach value and the difference between the sum of the marginal ratings values and the largest one of the first marginal ratings values.

Example 26 includes the apparatus of example 25, wherein the means for estimating is to perform a regression analysis with an independent variable based on the difference and a dependent variable based on the first reach value to determine parameter values of a double exponential model, and evaluate the double exponential model based on the parameter values and the second marginal ratings values to estimate the duplication factor.

Example 27 includes the apparatus of example 25, wherein the means for estimating is to perform a regression analysis based on the difference and the first reach value to estimate the duplication factor, and the means for outputting is to solve a system of equations to determine the second reach value, the system of equations based on the duplication factor and the second marginal ratings values.

Example 28 includes the apparatus of example 22, wherein the difference is a first difference, and the means for outputting is to determine a second difference between a sum of the second marginal ratings values and a largest one of the second marginal ratings values, and add the largest one of the second marginal ratings values to a product of the second difference and the duplication factor to determine the reach value.

Although certain example systems, methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to estimate a duplication factor, the apparatus comprising:
at least one memory;
instructions in the apparatus; and
processor circuitry to execute the instructions to at least:
access first marginal ratings values for a plurality of media segments, respective ones of the first marginal ratings values to represent respective portions of a first population associated with corresponding ones of the media segments;
estimate the duplication factor based on a difference between a sum of the first marginal ratings values and a largest one of the first marginal ratings values;
access second marginal ratings values for the plurality of media segments, respective ones of the second marginal ratings values to represent respective portions of a second population associated with corresponding ones of the media segments; and
output, based on the duplication factor and the second marginal ratings values, a reach value for a union of the media segments, the reach value to represent a number of unique individuals of the second population associated with at least one of the media segments.

2. The apparatus of claim 1, wherein the reach value is a second reach value, and the processor circuitry is to:
access a first reach value for the union of media segments, the first reach value to represent a number of unique individuals of the first population associated with at least one of the media segments; and
estimate the duplication factor based on the first reach value and the difference between the sum of the marginal ratings values and the largest one of the first marginal ratings values.

3. The apparatus of claim 2, wherein to estimate the duplication factor, the processor circuitry is to:
subtract the largest one of the first marginal ratings values from the first reach value to determine a difference value; and
divide the difference value by the difference between the sum of the marginal ratings values and the largest one of the first marginal ratings values to determine the duplication factor.

4. The apparatus of claim 1, wherein the first population corresponds to a historical version of the second population, the first population associated with a first interval prior to a second time interval of the second population, the reach value is a second reach value, and the processor circuitry is to:
access a first reach value for the union of media segments, the first reach value to represent a number of unique individuals of the first population associated with at least one of the media segments; and
estimate the duplication factor based on the first reach value and the difference between the sum of the marginal ratings values and the largest one of the first marginal ratings values.

5. The apparatus of claim 4, wherein the processor circuitry is to:
perform a regression analysis with an independent variable based on the difference and a dependent variable based on the first reach value to determine parameter values of a double exponential model; and
evaluate the double exponential model based on the parameter values and the second marginal ratings values to estimate the duplication factor.

6. The apparatus of claim 4, wherein the processor circuitry is to:
perform a regression analysis based on the difference and the first reach value to estimate the duplication factor; and
solve a system of equations to determine the second reach value, the system of equations based on the duplication factor and the second marginal ratings values.

7. The apparatus of claim 1, wherein the difference is a first difference, and the processor circuitry is to:
determine a second difference between a sum of the second marginal ratings values and a largest one of the second marginal ratings values; and
add the largest one of the second marginal ratings values to a product of the second difference and the duplication factor to determine the reach value.

8. At least one non-transitory computer readable medium comprising computer readable instructions that, when executed, cause at least one processor to at least:
access first marginal ratings values for a plurality of media segments, respective ones of the first marginal ratings values to represent respective portions of a first population associated with corresponding ones of the media segments;
estimate a duplication factor based on a difference between a sum of the first marginal ratings values and a largest one of the first marginal ratings values;
access second marginal ratings values for the plurality of media segments, respective ones of the second marginal ratings values to represent respective portions of a second population associated with corresponding ones of the media segments; and
output, based on the duplication factor and the second marginal ratings values, a reach value for a union of the media segments, the reach value to represent a number of unique individuals of the second population associated with at least one of the media segments.

9. The at least one non-transitory computer readable medium of claim 8, wherein the reach value is a second reach value, and the instructions cause the at least one processor to:
access a first reach value for the union of media segments, the first reach value to represent a number of unique individuals of the first population associated with at least one of the media segments; and
estimate the duplication factor based on the first reach value and the difference between the sum of the marginal ratings values and the largest one of the first marginal ratings values.

10. The at least one non-transitory computer readable medium of claim 9, wherein to estimate the duplication factor, the instructions cause the at least one processor to:
subtract the largest one of the first marginal ratings values from the first reach value to determine a difference value; and
divide the difference value by the difference between the sum of the marginal ratings values and the largest one of the first marginal ratings values to determine the duplication factor.

11. The at least one non-transitory computer readable medium of claim 8, wherein the first population corresponds to a historical version of the second population, the first population associated with a first interval prior to a second time interval of the second population, the reach value is a second reach value, and the instructions cause the at least one processor to:
access a first reach value for the union of media segments, the first reach value to represent a number of unique individuals of the first population associated with at least one of the media segments; and
estimate the duplication factor based on the first reach value and the difference between the sum of the marginal ratings values and the largest one of the first marginal ratings values.

12. The at least one non-transitory computer readable medium of claim 11, wherein the instructions cause the at least one processor to:
perform a regression analysis with an independent variable based on the difference and a dependent variable based on the first reach value to determine parameter values of a double exponential model; and
evaluate the double exponential model based on the parameter values and the second marginal ratings values to estimate the duplication factor.

13. The at least one non-transitory computer readable medium of claim 11, wherein the instructions cause the at least one processor to:
perform a regression analysis based on the difference and the first reach value to estimate the duplication factor; and
solve a system of equations to determine the second reach value, the system of equations based on the duplication factor and the second marginal ratings values.

14. The at least one non-transitory computer readable medium of claim 8, wherein the difference is a first difference, and the instructions cause the at least one processor to:
determine a second difference between a sum of the second marginal ratings values and a largest one of the second marginal ratings values; and
add the largest one of the second marginal ratings values to a product of the second difference and the duplication factor to determine the reach value.

15. A method to estimate a duplication factor, the method comprising:
accessing first marginal ratings values for a plurality of media segments, respective ones of the first marginal ratings values to represent respective portions of a first population associated with corresponding ones of the media segments;
estimating, by executing an instructions with at least one processor, a duplication factor based on a difference between a sum of the first marginal ratings values and a largest one of the first marginal ratings values;
accessing second marginal ratings values for the plurality of media segments, respective ones of the second marginal ratings values to represent respective portions of a second population associated with corresponding ones of the media segments; and
outputting, based on the duplication factor and the second marginal ratings values, a reach value for a union of the media segments, the reach value to represent a number of unique individuals of the second population associated with at least one of the media segments.

16. The method of claim 15, wherein the reach value is a second reach value, and further including:
accessing a first reach value for the union of media segments, the first reach value to represent a number of unique individuals of the first population associated with at least one of the media segments; and
estimating the duplication factor based on the first reach value and the difference between the sum of the marginal ratings values and the largest one of the first marginal ratings values.

17. The method of claim 16, wherein the estimating of the duplication factor includes:
subtracting the largest one of the first marginal ratings values from the first reach value to determine a difference value; and
dividing the difference value by the difference between the sum of the marginal ratings values and the largest one of the first marginal ratings values to determine the duplication factor.

18. The method of claim 15, wherein the first population corresponds to a historical version of the second population, the first population associated with a first interval prior to a second time interval of the second population, the reach value is a second reach value, and further including:
accessing a first reach value for the union of media segments, the first reach value to represent a number of unique individuals of the first population associated with at least one of the media segments; and
estimating the duplication factor based on the first reach value and the difference between the sum of the marginal ratings values and the largest one of the first marginal ratings values.

19. The method of claim 18, wherein the estimating of the duplication factor includes:
performing a regression analysis with an independent variable based on the difference and a dependent variable based on the first reach value to determine parameter values of a double exponential model; and
evaluating the double exponential model based on the parameter values and the second marginal ratings values to estimate the duplication factor.

20. The method of claim 18, wherein the estimating of the duplication factor includes:
performing a regression analysis based on the difference and the first reach value to estimate the duplication factor; and
solving a system of equations to determine the second reach value, the system of equations based on the duplication factor and the second marginal ratings values.

21. The method of claim 15, wherein the difference is a first difference, and further including:
determining a second difference between a sum of the second marginal ratings values and a largest one of the second marginal ratings values; and
adding the largest one of the second marginal ratings values to a product of the second difference and the duplication factor to determine the reach value.
